(19) United States
(12) Patent Application Publication
(10) Pub. No.: US 2023/0211776 A1
(43) Pub. Date: Jul. 6, 2023

(54) METHOD FOR DETERMINING ATTRIBUTE VALUE OF OBSTACLE IN VEHICLE INFRASTRUCTURE COOPERATION, DEVICE AND AUTONOMOUS DRIVING VEHICLE

(71) Applicant: Apollo Intelligent Driving Technology (Beijing) Co., Ltd., Beijing (CN)

(72) Inventors: Ye Yang, Beijing (CN); Ye Zhang, Beijing (CN)

(73) Assignee: Apollo Intelligent Driving Technology (Beijing) Co., Ltd., Beijing (CN)

(21) Appl. No.: 18/116,066

(22) Filed: Mar. 1, 2023

(30) Foreign Application Priority Data
Mar. 2, 2022 (CN) 202210200285.8

(51) Int. Cl. B60W 30/08; B60W 60/00; H04W 4/40

(52) U.S. Cl. CPC B60W 30/08; B60W 60/0015; H04W 4/40; B60W 2556/45; B60W 2556/35; B60W 2554/4042; B60W 2554/4041; B60W 2554/80

(57) ABSTRACT

The present disclosure provides a method and apparatus for determining an attribute value of an obstacle in vehicle infrastructure cooperation. The method includes: acquiring vehicle-end data collected by at least one sensor of an autonomous driving vehicle; acquiring vehicle wireless communication V2X data transmitted by a roadside device; and fusing, in response to determining that an obstacle is at an edge of a blind spot of the autonomous driving vehicle, the vehicle-end data and the V2X data to obtain an attribute estimated value of the obstacle.

### CROSS-REFERENCE TO RELATED APPLICATIONS

This patent application claims the priority of Chinese Patent Application No. 202210200285.8, filed on Mar. 2, 2022, and entitled “Method for Determining Attribute Value of Obstacle in Vehicle Infrastructure Cooperation, Device and Autonomous Driving Vehicle”, the entire content of which is incorporated herein by reference.

### TECHNICAL FIELD

The present disclosure relates to the technical field of artificial intelligence, in particular to the technical fields of autonomous driving, intelligent transportation, vehicle infrastructure cooperation, and deep learning, and more particular, to a method for determining an attribute value of an obstacle in vehicle infrastructure cooperation, a device and an autonomous driving vehicle.

### BACKGROUND

With the development of autonomous driving technology, a variety of unmanned vehicles appear on the market. When an existing unmanned vehicle is in an autonomous driving mode, a detection element of the unmanned vehicle usually is required to detect obstacles in a travelling direction, and to estimate attributes of the obstacles based on a detection result.

### SUMMARY

The present disclosure provides a method for determining an attribute value of an obstacle in vehicle infrastructure cooperation, a device and an autonomous driving vehicle.

According to a first aspect of the present disclosure, a method for determining an attribute value of an obstacle is provided. The method includes: acquiring vehicle-end data collected by at least one sensor of an autonomous driving vehicle; acquiring vehicle wireless communication vehicle to everything (V2X) data transmitted by a roadside device; and fusing, in response to determining that an obstacle is at an edge of a blind spot of the autonomous driving vehicle, the vehicle-end data and the V2X data to obtain an attribute estimated value of the obstacle.

According to a second aspect of the present disclosure, an apparatus for determining an attribute value of an obstacle is provided. The apparatus includes: a first acquisition module, configured to acquire vehicle-end data collected by at least one sensor of an autonomous driving vehicle; a second acquisition module, configured to acquire vehicle wireless communication vehicle to everything (V2X) data transmitted by a roadside device; and a fusion module, configured to fuse, in response to determining that an obstacle is at an edge of a blind spot of the autonomous driving vehicle, the vehicle-end data and the V2X data to obtain an attribute estimated value of the obstacle.

According to a third aspect of the present disclosure, an electronic device is provided. The electronic device includes: at least one processor; and a memory communicatively connected to the at least one processor. The memory stores instructions executable by the at least one processor, and the instructions, when executed by the at least one processor, cause the at least one processor to perform the method according to any implementation in the first aspect.

According to a fourth aspect of the present disclosure, a non-transitory computer readable storage medium storing computer instructions is provided. The computer instructions are used to cause the computer to perform the method according to any implementation in the first aspect.

According to a sixth aspect of the present disclosure, an autonomous driving vehicle is provided. The autonomous driving vehicle includes the electronic device according to the third aspect.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

The accompanying drawings are used for better understanding of the present solution, and do not constitute a limitation to the present disclosure.

FIG. 1 is an exemplary system architecture diagram to which embodiments of the present disclosure may be applied;

FIG. 2 is a flowchart of a method for determining an attribute value of an obstacle according to an embodiment of the present disclosure;

FIG. 3 is a flowchart of the method for determining an attribute value of an obstacle according to another embodiment of the present disclosure;

FIG. 4 is a flowchart of the method for determining an attribute value of an obstacle according to yet another embodiment of the present disclosure;

FIG. 5 is a flowchart of the method for determining an attribute value of an obstacle according to yet another embodiment of the present disclosure;

FIG. 6 is an application scenario diagram of the method for determining an attribute value of an obstacle according to an embodiment of the present disclosure;

FIG. 7 is a schematic structural diagram of an apparatus for determining an attribute value of an obstacle according to an embodiment of the present disclosure; and

FIG. 8 is a block diagram of an electronic device used to implement the method for determining an attribute value of an obstacle according to embodiments of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope and spirit of the present disclosure. Similarly, for clearness and conciseness, descriptions of well-known functions and structures are omitted in the following description.

It should be noted that the embodiments of the present disclosure and features of the embodiments may be combined with each other on a non-conflict basis. The present disclosure will be described in detail below with reference to the accompanying drawings and in conjunction with the embodiments.

FIG. 1 illustrates an exemplary system architecture 100 of an embodiment of a method for determining an attribute value of an obstacle or an apparatus for determining an attribute value of an obstacle to which the present disclosure may be applied.

As shown in FIG. 1, the system architecture 100 may include a device 101, a network 102 and an autonomous driving vehicle 103. The network 102 serves as a medium providing a communication link between the device 101 and autonomous driving vehicle 103. The network 102 may include various types of connections, such as wired or wireless communication links, or optical cables.

The device 101 may be a roadside device or a background of a roadside device, which may be hardware or software.

The autonomous driving vehicle 103 may interact with the device 101 via the network 102 to receive or send messages, and the like. For example, the autonomous driving vehicle 103 may acquire vehicle-end data, and may also acquire V2X data from the device 101, then analyze and process the vehicle-end data and the V2X data, and generate a processing result (e.g., obtain an attribute estimated value of an obstacle).

It should be noted that the method for determining an attribute value of an obstacle provided by embodiments of the present disclosure is generally performed by the autonomous driving vehicle 103, and accordingly, the apparatus for determining an attribute value of an obstacle is generally provided in the autonomous driving vehicle 103.

It should be understood that the numbers of devices, networks and autonomous driving vehicles in FIG. 1 are merely illustrative. Any number of devices, networks and autonomous driving vehicles may be provided according to implementation needs.

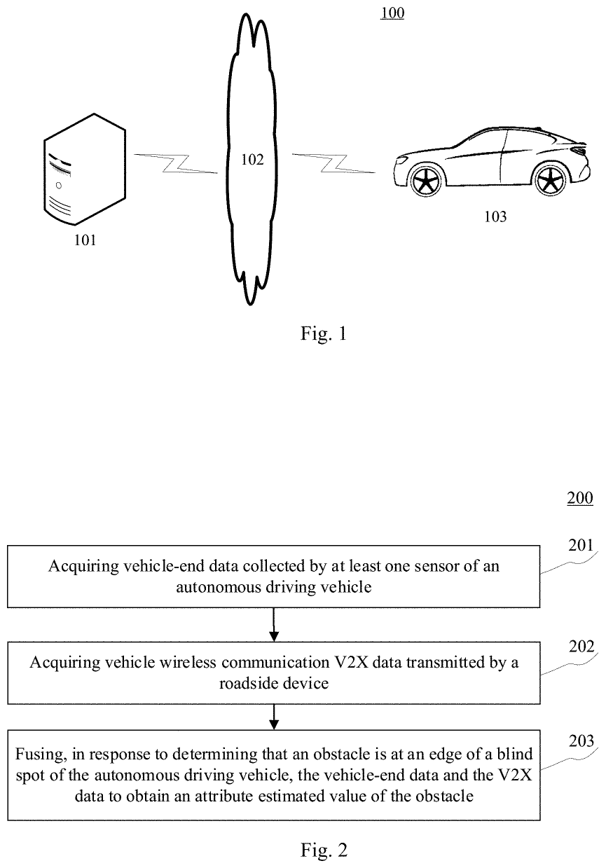

With further reference to FIG. 2, illustrating a flow 200 of a method for determining an attribute value of an obstacle according to an embodiment of the present disclosure. The method for determining an attribute value of an obstacle includes the following steps.

Step 201 includes acquiring vehicle-end data collected by at least one sensor of an autonomous vehicle.

In the present embodiment, an executing body of the method for determining an attribute value of an obstacle is an autonomous driving vehicle, and the executing body may acquire the vehicle-end data collected by the at least one sensor of the autonomous vehicle. The autonomous vehicle may be an unmanned car or a vehicle having an autonomous driving mode.

Here, the sensor may be a point cloud sensor or an image sensor. The point cloud sensor is a sensor that may collect point cloud data, generally a 3D (3-dimension) sensor. The point cloud sensor includes a Light detection and ranging (Lidar) sensor and a radio detection and ranging (Radar) sensor. The image sensor is a sensor that may collect images, generally a 2D (2-dimension) sensor, such as a camera sensor.

The executing body may acquire the vehicle-end data collected by the at least one sensor installed on the unmanned vehicle.

Step 202 includes acquiring vehicle wireless communication V2X data transmitted by a roadside device.

In the present embodiment, the executing body may acquire the vehicle wireless communication V2X data transmitted by the roadside device. V2X (vehicle to X or Vehicle to Everything) refers to vehicle wireless communication technology, also known as vehicle-to-everything communication. V2X enables vehicles to obtain a series 5 of traffic information such as real-time road conditions, road information, and pedestrian information, which improves driving safety, reduces congestion, improves traffic efficiency, etc. Here, V represents the vehicle, and X represents any object that interacts with the vehicle. Currently, X mainly includes vehicle (Vehicle to Vehicle, V2V), person (Vehicle to Pedestrian, V2P), traffic roadside infrastructure (Vehicle to Infrastructure, V2I) and network (Vehicle to Network, V2N). The V2X technology may be applied to various vehicles, and vehicles equipped with V2X technology-related apparatuses may receive roadside messages.

In the present embodiment, the V2X data refers to data transmitted by a roadside device, and the roadside device refers to equipment installed on both sides of a road, which may be a roadside unit (RSU) or a roadside computing unit (RSCU), or an edge computing unit MEC (Multi-access Edge Computing). The roadside device acts as a message transmission intermediary, and transmits roadside messages such as road traffic collected by the roadside device to assist the vehicle to travel safely. The V2X data may include attribute information such as position information, speed information of vehicles on the road, or map information about locations and attributes of intersections and lanes, or data such as timestamps during transmission of the roadside device RSU.

The executing body may acquire the V2X data transmitted by the roadside device.

Step 203 includes fusing, in response to determining that an obstacle is at an edge of a blind spot of the autonomous vehicle, the vehicle-end data and the V2X data to obtain an attribute estimated value of the obstacle.

In the present embodiment, in response to determining that the obstacle is at the edge of the blind spot of the autonomous vehicle, the executing body may fuse the acquired vehicle-end data and the V2X data to determine the attribute estimated value of the obstacle based on a fusion result. Alternatively, since the vehicle-end data contains the data collected by the at least one sensor in the vehicle-end, the executing body may determine a relative positional relationship between the obstacle and the autonomous vehicle based on a blocked area of the obstacle in the vehicle-end data, that is, whether the obstacle is in the blind spot of the autonomous vehicle, outside the blind spot of the autonomous vehicle, or at the edge of the blind spot of the autonomous vehicle, and if it is determined that the obstacle is at the edge of the blind spot of the autonomous driving vehicle, fuse the vehicle-end data and the V2X data to obtain the attribute estimated value of the obstacle. The attribute estimated value may be a speed estimated value, a position estimated value, a category estimated value, or the like, which is not limited in the present embodiment. In some cases, after obtaining the attribute estimated value of the obstacle, the executing body may also make decisions and control the autonomous driving vehicle based on the attribute estimated value obtained from the fusion result, such as avoiding an obstacle, braking, reducing vehicle speed, or re-planning a route.

It should be noted that if the obstacle is located in the blind spot of the autonomous driving vehicle (completely invisible), the vehicle cannot detect the obstacle, then attributes of the obstacle are estimated based on the V2X data. If the obstacle is located outside the blind spot of the autonomous driving vehicle (completely visible), the vehicle may detect the obstacle, and at the same time a V2X result may be associated. In this regard, the attributes of the obstacle are estimated using the vehicle-end data.

As an example, when estimating a speed of the obstacle at the edge of the blind spot of the autonomous driving vehicle, a speed observed value collected by each sensor in the vehicle-end data and a speed observed value of the obstacle in the V2X data may be input into a pre-trained observation model together, so that the observation model may determine confidence levels of the speed observed values, and input a result into a pre-trained motion model, thereby obtaining the speed estimated value of the obstacle.

As another example, when estimating a category of the obstacle at the edge of the blind spot of the autonomous driving vehicle, a category observed value collected by each sensor in the vehicle-end data and a category observed value of the obstacle in the V2X data may be input into a pre-trained hidden Markov model together to fuse the vehicle-end data and the V2X data, so as to output to obtain the category estimated value of the obstacle.

Alternatively, for the obstacle located at the edge of the blind spot of the autonomous driving vehicle, if a V2X signal is associated with this obstacle, a higher probability may be assigned to the obstacle during existence modeling, so as to help the vehicle to report the detected object in time, and also help the vehicle to eliminate uncertainty. In addition, green plant judgment, dead car judgment, construction area judgment, etc. may also be performed, all of which may be performed by the roadside V2X data (based on long-term observation of intersections), to help the vehicle directly replace or probabilistic fuse an original vehicle-end result, when the vehicle travels to a V2X intersection.

The method for determining an attribute value of an obstacle provided by this embodiment of the present disclosure, first acquires the vehicle-end data collected by the at least one sensor of the autonomous driving vehicle; then acquires the vehicle wireless communication V2X data transmitted by the roadside device; and finally, in response to determining that the obstacle is at the edge of the blind spot of the autonomous driving vehicle, performs data fusion on the vehicle-end data and the V2X data (the two kinds of perception data), to obtain the attribute estimated value of the obstacle by means of perceptual fusion. In the method for determining an attribute value of an obstacle in the present embodiment, in the process of estimating the attribute value of the obstacle, the method uses a vehicle infrastructure cooperation approach to fuse the vehicle-end data and the V2X data, thereby making full use of the attribute information of the converged obstacle in the V2X data, making the data more complete and accurate, shortening attribute convergence time of the obstacle, and also avoiding occurrence of attribute jumping at the same time; in addition, the method has higher robustness, better timeliness and higher scalability due to the introduction of more information (vehicle-end data and V2X data).

In the technical solution of the present disclosure, the collection, storage, use, processing, transmission, provision and disclosure of the user personal information involved are in compliance with relevant laws and regulations, and do not violate public order and good customs.

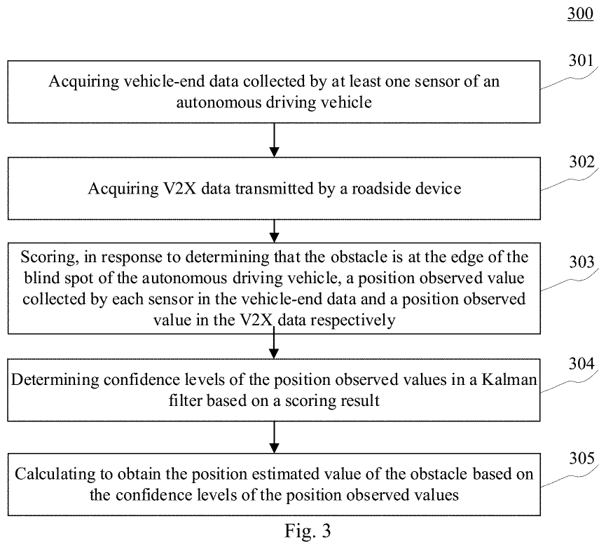

With further reference to FIG. 3, FIG. 3 illustrates a flow 300 of the method for determining an attribute value of an obstacle according to another embodiment of the present disclosure. The method for determining an attribute value of an obstacle includes the following steps.

Step 301 includes acquiring vehicle-end data collected by at least one sensor of an autonomous driving vehicle.

Step 302 includes acquiring V2X data transmitted by a roadside device.

Steps 301-302 are basically the same as steps 201-202 in the foregoing embodiment, and for a specific implementation, reference may be made to the foregoing description of steps 201-202, detailed description thereof will be omitted.

In some alternative implementations of the present embodiment, after step 301, the method for determining an attribute value of an obstacle further includes: determining, based on a blocked area of the obstacle in the vehicle-end data, whether the obstacle is at the edge of the blind spot of the autonomous driving vehicle.

In this implementation, after acquiring the vehicle-end data collected by the at least one sensor of the autonomous driving vehicle, the executing body may determine a relative position of the obstacle and the blind spot of the autonomous driving vehicle based on the blocked area of the obstacle in the data collected by one or more sensors in the acquired vehicle-end data. For example, it may be determined whether the obstacle is at the edge of the blind spot of the autonomous driving vehicle based on the point cloud data collected by the Lidar sensor or the Radar sensor in the vehicle-end data. As another example, it may also be determined whether the obstacle is at the edge of the blind spot of the autonomous driving vehicle based on an image collected by the camera sensor in the vehicle-end data. If only part of the data of the obstacle is displayed in the vehicle-end data, it indicates that the obstacle has a blocked area, so the obstacle is located at the edge of the blind spot of the autonomous driving vehicle. Thus, it may be more accurately and quickly determined whether the obstacle is located at the edge of the blind spot of the autonomous driving vehicle.

Step 303 includes scoring, in response to determining that the obstacle is at the edge of the blind spot of the autonomous driving vehicle, a position observed value collected by each sensor in the vehicle-end data and a position observed value in the V2X data respectively.

In the present embodiment, the executing body (autonomous driving vehicle) of the method for determining an attribute value of an obstacle may, in response to determining that the obstacle is at the edge of the blind spot of the autonomous driving vehicle, score the position observed value collected by each sensor in the vehicle-end data and the position observed value in the V2X data respectively.

Specifically, an observation model may be used to score the position observed value collected by each sensor in the vehicle-end data and the position observed value in the V2X data. A scoring basis mainly considers capabilities of each sensor in different scenarios. For example, the position observed value collected by each sensor in the vehicle-end data and the position observed value in the V2X data may be input into the observation model, to output to obtain a score of 4 points for the position observed value of the Lidar sensor in the vehicle end, a score of 5 points for the position observed value of the Radar sensor in the vehicle end, and a score of 5 points for the position observed value in the V2X data. The observation model is obtained by training based on pre-statistical data collected by each sensor and a scoring result of the data.

Step 304 includes determining confidence levels of the position observed values in a Kalman filter based on a scoring result.

In the present embodiment, the executing body may determine the respective confidence levels of the position observed values in the Kalman filter based on the scoring result. A score in the scoring result can affect the confidence level of the position observed value, the higher the score, the higher the confidence level. For example, the position observed value of the Lidar sensor in the vehicle end is scored 4 points, and its corresponding confidence level is 4; the position observed value in the V2X data is scored 5 points, and its corresponding confidence level is 5.

Step 305 includes calculating to obtain the position estimated value of the obstacle based on the confidence levels of the position observed values.

In the present embodiment, the executing body may calculate to obtain the position estimated value of the obstacle based on the confidence levels of the position observed values. For example, the position observed value collected by each sensor in the vehicle-end data and the position observed value in the V2X data, as well as the confidence levels corresponding to the position observed values, may be input into the Kalman filter, to output to obtain the position estimated value of the obstacle. The Kalman filter is the motion model in the present embodiment, and Kalman filtering is an algorithm for optimally estimating a system state by using a linear system state equation, through system input and output observation data.

In some alternative implementations of the present embodiment, step 305 includes: determining an R matrix in the Kalman filter corresponding to the position observed values based on the confidence levels of the position observed values; and calculating to obtain the position estimated value of the obstacle based on the R matrix.

In this implementation, different confidence levels correspond to different R matrices in the Kalman filter, that is, the confidence level determines a weight coefficient of the position observed value, that is, the confidence level determines whether to use the position observed value more. The executing body may determine the R matrix in the Kalman filter corresponding to the position observed value based on the confidence level corresponding to each position observed value, and then calculate to obtain the position estimated value of the obstacle based on the determined R matrix. The R matrix in the Kalman filter corresponding to the position observed value is determined by the confidence levels corresponding to the position observed values, so as to calculate to obtain the position estimated value of the obstacle, so as to make full use of each data in the process of data fusion, thus, a speed of estimating the position attribute of the obstacle is improved, and an accuracy of estimating the position attribute of the obstacle is also improved.

As can be seen from FIG. 3, compared with the embodiment corresponding to FIG. 2, the method for determining an attribute value of an obstacle in the present embodiment realizes the estimation of the position attribute of the obstacle, and in the attribute estimation process, the position observed value collected by each sensor in the vehicle end and the position observed value in the V2X data are fused, thereby improving an accuracy of the obtained position estimated value.

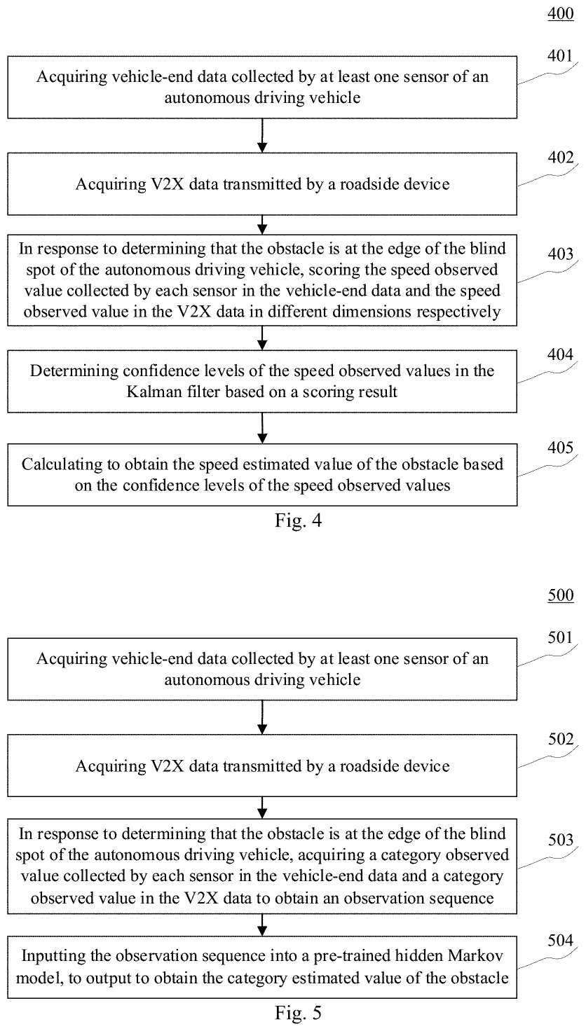

With further reference to FIG. 4, FIG. 4 illustrates a flow 400 of yet another embodiment of the method for determining an attribute value of an obstacle according to the present disclosure. The method for determining an attribute value of an obstacle includes the following steps.

Step 401 includes acquiring vehicle-end data collected by at least one sensor of an autonomous driving vehicle.

Step 402 includes acquiring V2X data transmitted by a roadside device.

Steps 401-402 are basically the same as steps 201-202 in the foregoing embodiment, and for a specific implementation, reference may be made to the foregoing description of steps 201-202, detailed description thereof will be omitted.

Step 403 includes, in response to determining that the obstacle is at the edge of the blind spot of the autonomous driving vehicle, scoring the speed observed value collected by each sensor in the vehicle-end data and the speed observed value in the V2X data in different dimensions respectively.

In the present embodiment, the executing body (autonomous driving vehicle) of the method for determining an attribute value of an obstacle may, in response to determining that the obstacle is at the edge of the blind spot of the autonomous driving vehicle, score the speed observed value collected by each sensor in the vehicle-end data and the speed observed value in the V2X data in different dimensions respectively, where the different dimensions include a size dimension, a direction dimension, and a dynamic and static dimension.

Specifically, an observation model may be used to score the speed observed value collected by each sensor in the vehicle-end data and the speed observed value in the V2X data in three dimensions, namely size, direction, and dynamic and static. A scoring basis mainly considers capabilities of each sensor in different scenarios. For example, the speed observed value collected by each sensor in the vehicle-end data and the speed observed value in the V2X data may be input into the observation model, to output to obtain a score of 4 points in the size dimension for the speed observed value of the Lidar sensor in the vehicle end, a score of 3 points in the direction dimension, and a score of 3 points in the dynamic and static dimension; and a score of 5 points in the size dimension for the speed observed value in the V2X data, a score of 3 points in the direction dimension, and a score of 5 points in the dynamic and static dimension. The observation model is obtained by training based on pre-statistical data collected by each sensor and a scoring result of the data.

It should be noted that, considering that speed estimation often requires the Kalman filter to be updated with an initial value of 0 m/s, and for the speed of the obstacle at the edge of the blind spot of the vehicle, it takes some time for the speed to converge from 0 m/s to a correct speed value, and the roadside V2X data contains converged speed information of the obstacle, therefore, the observation model may give higher scores to the speed and the dynamic and static state of the converged speed information in the V2X data, so that the speed and the dynamic and static state are more fully used by the filter, thereby accelerating the convergence of a speed result.

Step 404 includes determining confidence levels of the speed observed values in the Kalman filter based on a scoring result.

In the present embodiment, the executing body may determine the confidence levels of the speed observed values in the Kalman filter based on the scoring result. A score in the scoring result affects the confidence level of the speed observed value, the higher the score, the higher the confidence level. For example, the confidence level corresponding to the scoring result of the speed observed value of the Lidar sensor in the vehicle end is 4; and the confidence level corresponding to the scoring result of the speed observed value in the V2X data is 5.

Step 405 includes calculating to obtain the speed estimated value of the obstacle based on the confidence levels of the speed observed values.

In the present embodiment, the executing body may calculate to obtain the speed estimated value of the obstacle based on the confidence levels of the speed observed values. For example, the speed observed value collected by each sensor in the vehicle-end data and the speed observed value in the V2X data, as well as the confidence levels corresponding to the speed observed values, may be input into the Kalman filter, to output to obtain the speed estimated value of the obstacle.

In some alternative implementations of the present embodiment, step 405 includes: determining an R matrix in the Kalman filter corresponding to the speed observed values based on the confidence levels of the speed observed values; and calculating to obtain the speed estimated value of the obstacle based on the R matrix.

In this implementation, different confidence levels correspond to different R matrices in the Kalman filter, that is, the confidence level determines a weight coefficient of the speed observed value, that is, the confidence level determines whether to use the speed observed value more. The executing body may determine the R matrix in the Kalman filter corresponding to the speed observed value based on the confidence level corresponding to each speed observed value, and then calculate to obtain the speed estimated value of the obstacle based on the determined R matrix. The R matrix in the Kalman filter corresponding to the speed observed value is determined by the confidence levels corresponding to the speed observed values, so as to calculate to obtain the speed estimated value of the obstacle, so as to make full use of each data in the process of data fusion, thus, a speed of estimating the speed attribute of the obstacle is improved, and an accuracy of estimating the speed attribute of the obstacle is also improved.

As can be seen from FIG. 4, compared with the embodiment corresponding to FIG. 3, the method for determining an attribute value of an obstacle in the present embodiment realizes the estimation of the speed attribute of the obstacle, and in the attribute estimation process, the speed observed value collected by each sensor in the vehicle end and the speed observed value in the V2X data are fused, thereby accelerating the convergence process of the speed attribute of the obstacle, and also improving an accuracy of the obtained speed estimated value.

With further reference to FIG. 5, FIG. 5 illustrates a flow 500 of the method for determining an attribute value of an obstacle according to yet another embodiment of the present disclosure. The method for determining an attribute value of an obstacle includes the following steps.

Step 501 includes acquiring vehicle-end data collected by at least one sensor of an autonomous driving vehicle.

Step 502 includes acquiring V2X data transmitted by a roadside device.

Steps 501-502 are basically the same as steps 201-202 in the foregoing embodiment, and for a specific implementation, reference may be made to the foregoing description of steps 201-202, detailed description thereof will be omitted.

Step 503 includes, in response to determining that the obstacle is at the edge of the blind spot of the autonomous driving vehicle, acquiring a category observed value collected by each sensor in the vehicle-end data and a category observed value in the V2X data to obtain an observation sequence.

In the present embodiment, the executing body (autonomous driving vehicle) of the method for determining an attribute value of an obstacle may, in response to determining that the obstacle is at the edge of the blind spot of the autonomous driving vehicle, acquire the category observed value collected by each sensor in the vehicle-end data and the category observed value in the V2X data respectively, thereby obtaining the observation sequence containing the category observed values, so that the observation sequence contains both the data collected by each sensor in the vehicle end and the category observed value aggregated by the V2X data.

Step 504 includes inputting the observation sequence into a pre-trained hidden Markov model, to output to obtain the category estimated value of the obstacle.

In the present embodiment, the executing body may input the observation sequence into the pre-trained hidden Markov model, to output to obtain the category estimated value of the obstacle.

Hidden Markov Model (HMM) is a probability model on time series, which describes a process of randomly generating an unobservable state random sequence from a hidden Markov chain, and then generating an observation from each state to generate a random sequence of observations.

In the present embodiment, the executing body may first perform time series modeling, that is, modeling according to time series. First, problem construction: given the observation sequence O={O₁, O₂, . . . , Oₜ}, and the HMM model λ=(A, B, π), where π is an initial state probability matrix, A is a state transition probability matrix, and B is an observation state transition probability matrix, how to choose a corresponding state sequence I={i₁, i₂, . . . , iₜ}, so that the state sequence I can most reasonably explain the observation sequence O, that is, inputting a sensor input type sequence, and wishing to obtain a fused output type sequence, which is a prediction problem.

Therefore, in the present embodiment, a Viterbi algorithm is applied to solve this problem, that is, a model for solving this problem is constructed, that is, the Hidden Markov Model trained in the present embodiment. The Viterbi algorithm is a dynamic programming algorithm used to find a Viterbi path-hidden state sequence that is most likely to generate an observation event sequence, especially in a context of Markov information sources and the hidden Markov model.

After the HMM model is constructed, its state transition probability matrix A and its observation state transition probability matrix B are also determined. Therefore, after inputting the observation sequence into the HMM model, the executing body may use A and B to perform a series of calculations to output to obtain the category estimated value of the obstacle.

It should be noted that the initial state probability matrix π represents a probability matrix of a hidden state at initial time t=1; the state transition probability matrix A describes a transition probability between states in the HMM model; and the observation state transition probability matrix (also called confusion matrix) B represents a probability that an observation state is Oᵢ under the condition that the hidden state is Sⱼ at time t. Here, the confusion matrix is determined based on the data collected by each sensor in the vehicle-end data and a category accuracy of the V2X data on truth data.

In some alternative implementations of the present embodiment, step 504 includes: obtaining state types corresponding to the category observed values in the observation sequence, based on a state transition probability matrix in the hidden Markov model; and fusing, based on an observation state transition probability matrix in the hidden Markov model, the state types corresponding to the category observed values, to obtain the category estimated value of the obstacle.

In this implementation, since the state transition probability matrix A describes the transition probability between the states in the HMM model, based on the state transition probability matrix A in the HMM model, probabilities of the state types corresponding to the category observed values in the observation sequence may be calculated to obtain, thereby determining the state types corresponding to the category observed values. Secondly, since the observation state transition probability matrix (also called confusion matrix) B represents the probability that the observation state is Oᵢ under the condition that the hidden state is Sⱼ at the time t, based on the observation state transition probability matrix B in the HMM model, a current optimal state may be calculated to obtain, that is, after the state types corresponding to the category observed values are fused, the category estimated value of the obstacle may be obtained, where the category may include people, vehicles, bicycles, unknow, etc. Thus, the category attribute of the obstacle may be estimated, and an accuracy of the obtained category estimated value may be improved.

As can be seen from FIG. 5, compared with the embodiment corresponding to FIG. 4, the method for determining an attribute value of an obstacle in the present embodiment realizes the estimation of the category attribute of the obstacle, and in the attribute estimation process, the category observed value collected by each sensor in the vehicle end and the category observed value in the V2X data are fused, thereby improving the accuracy of the obtained category estimated value.

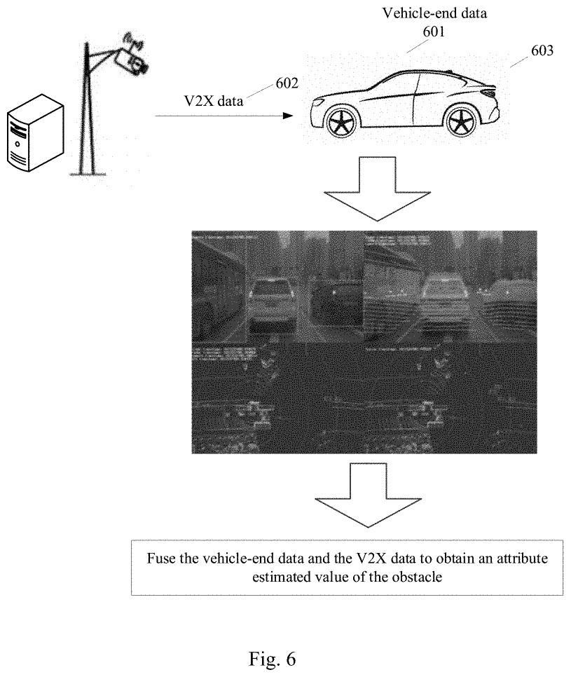

With further reference to FIG. 6, FIG. 6 illustrates an application scenario of the method for determining an attribute value of an obstacle according to the present disclosure. In this application scenario, first, an executing body 603 (autonomous driving vehicle) may acquire vehicle-end data 601 collected by at least one sensor on the vehicle, and acquire V2X data 602 transmitted by a roadside device. Then, the executing body may determine that an obstacle is at an edge of a blind spot of the autonomous driving vehicle based on a blocked area of the obstacle in the vehicle-end data 601. Next, the executing body may fuse the vehicle-end data 601 and the V2X data 602 to obtain an attribute estimated value of the obstacle, where the attribute estimated value includes a speed estimated value, a position estimated value and a category estimated value. Specifically, the executing body may score the position observed value and/or the speed observed value collected by each sensor in the vehicle-end data and the position observed value and/or the speed observed value in the V2X data respectively, then based on a scoring result, determine confidence levels of the position observed values and/or the speed observed values in a Kalman filter, and then based on the confidence levels of the attribute observed values, calculate to obtain the position estimate value and/or the speed estimate value of the obstacle.

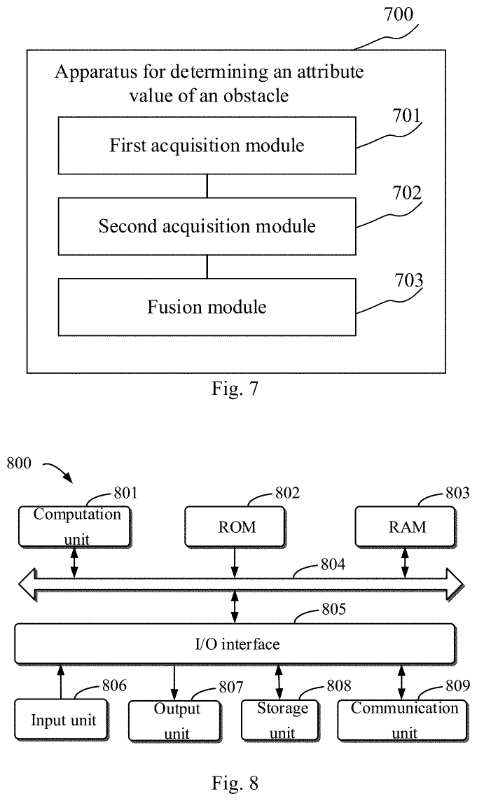

With further reference to FIG. 7, as an implementation of the method shown in the above figures, an embodiment of the present disclosure provides an apparatus for determining an attribute value of an obstacle, which corresponds to the method embodiment shown in FIG. 2, and the apparatus may be applied to various electronic devices.

As shown in FIG. 7, an apparatus 700 for determining an attribute value of an obstacle of the present embodiment includes: a first acquisition module 701, a second acquisition module 702 and a fusion module 703. The first acquisition module 701 is configured to acquire vehicle-end data collected by at least one sensor of an autonomous driving vehicle. The second acquisition module 702 is configured to acquire vehicle wireless communication V2X data transmitted by a roadside device. The fusion module 703 is configured to fuse, in response to determining that an obstacle is at an edge of a blind spot of the autonomous driving vehicle, the vehicle-end data and the V2X data to obtain an attribute estimated value of the obstacle.

In the present embodiment, in the apparatus 700 for determining an attribute value of an obstacle: for the specific processing and the technical effects of the first acquisition module 701, the second acquisition module 702 and the fusion module 703, reference may be made to the relevant descriptions of steps 201-203 in the corresponding embodiment of FIG. 2 respectively, and detailed description thereof will be omitted.

In some alternative implementations of the present embodiment, the apparatus 700 for determining an attribute value of an obstacle further includes: a determination module, configured to determine, based on a blocked area of the obstacle in the vehicle-end data, whether the obstacle is at the edge of the blind spot of the autonomous driving vehicle.

In some alternative implementations of the present embodiment, the attribute estimated value includes a position estimated value and/or a speed estimated value; and the fusion module includes: a scoring submodule, configured to score an attribute observed value collected by each sensor in the vehicle-end data and an attribute observed value in the V2X data respectively, where the attribute observed value includes a position observed value and/or a speed observed value; a determination submodule, configured to determine confidence levels of the attribute observed values in a Kalman filter based on a scoring result; and a calculation submodule, configured to calculate to obtain the position estimated value and/or the speed estimated value of the obstacle based on the confidence levels of the attribute observed values.

In some alternative implementations of the present embodiment, the calculation submodule includes: a first determination unit, configured to determine an R matrix in the Kalman filter corresponding to the attribute observed values based on the confidence levels of the attribute observed values; and a calculation unit, configured to calculate to obtain the position estimated value and/or the speed estimated value of the obstacle based on the R matrix.

In some alternative implementations of the present embodiment, in response to determining that the attribute estimated value includes the speed estimated value, the scoring submodule is further configured to: score the speed observed value collected by each sensor in the vehicle-end data and the speed observed value in the V2X data in different dimensions respectively, where the different dimensions include a size dimension, a direction dimension, and a dynamic and static dimension.

In some alternative implementations of the present embodiment, the attribute estimated value includes a category estimated value; and the fusion module includes: an acquisition submodule, configured to acquire a category observed value collected by each sensor in the vehicle-end data and a category observed value in the V2X data to obtain an observation sequence; and an output submodule, configured to input the observation sequence into a pre-trained hidden Markov model, to output to obtain the category estimated value of the obstacle.

In some alternative implementations of the present embodiment, the output submodule includes: a second determination unit, configured to obtain state types corresponding to the category observed values in the observation sequence, based on a state transition probability matrix in the hidden Markov model; and a third determination unit, configured to fuse, based on an observation state transition probability matrix in the hidden Markov model, the state types corresponding to the category observed values, to obtain the category estimated value of the obstacle.

According to an embodiment of the present disclosure, the present disclosure also provides an electronic device, a readable storage medium, a computer program product and an autonomous driving vehicle.

FIG. 8 illustrates a schematic block diagram of an example electronic device 800 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The parts shown herein, their connections and relationships, and their functions are merely examples, and are not intended to limit the implementation of the present disclosure described and/or claimed herein.

As shown in FIG. 8, the device 800 includes a computing unit 801, which may perform various appropriate actions and processing, based on a computer program stored in a read-only memory (ROM) 802 or a computer program loaded from a storage unit 808 into a random access memory (RAM) 803. In the RAM 803, various programs and data required for the operation of the device 800 may also be stored. The computing unit 801, the ROM 802, and the RAM 803 are connected to each other through a bus 804. An input/output (I/O) interface 805 is also connected to the bus 804.

A plurality of parts in the device 800 are connected to the I/O interface 805, including: an input unit 806, for example, a keyboard and a mouse; an output unit 807, for example, various types of displays and speakers; the storage unit 808, for example, a disk and an optical disk; and a communication unit 809, for example, a network card, a modem, or a wireless communication transceiver. The communication unit 809 allows the device 800 to exchange information/data with other devices over a computer network such as the Internet and/or various telecommunication networks.

The computing unit 801 may be various general-purpose and/or dedicated processing components having processing and computing capabilities. Some examples of the computing unit 801 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 801 performs the various methods and processes described above, such as a method for determining an attribute value of an obstacle. For example, in some embodiments, the method for determining an attribute value of an obstacle may be implemented as a computer software program, which is tangibly included in a machine readable medium, such as the storage unit 808. In some embodiments, part or all of the computer program may be loaded and/or installed on the device 800 via the ROM 802 and/or the communication unit 809. When the computer program is loaded into the RAM 803 and executed by the computing unit 801, one or more steps of the method for determining an attribute value of an obstacle described above may be performed. Alternatively, in other embodiments, the computing unit 801 may be configured to perform the method for determining an attribute value of an obstacle by any other appropriate means (for example, by means of firmware).

The autonomous driving vehicle provided in the present disclosure may include the above electronic device as shown in FIG. 8, and the electronic device can implement the method for determining an attribute value of an obstacle described in any of the above embodiments when executed by a processor.

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine- readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

Cloud computer refers to a technical system that accesses to a shared physical or virtual resource pool that is elastic and scalable through a network, where resources may include servers, operating systems, networks, software, applications or storage devices, etc., and may deploy and manage resources in a on-demand and self-service manner. Through cloud computing technology, it can provide efficient and powerful data processing capabilities for artificial intelligence, blockchain and other technical applications and model training.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, a distributed system server, or a server combined with a blockchain.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for determining an attribute value of an obstacle, the method comprising:
acquiring vehicle-end data collected by at least one sensor of an autonomous driving vehicle;
acquiring vehicle wireless communication vehicle to everything (V2X) data transmitted by a roadside device; and
fusing, in response to determining that an obstacle is at an edge of a blind spot of the autonomous driving vehicle, the vehicle-end data and the V2X data to obtain an attribute estimated value of the obstacle.

2. The method according to claim 1, further comprising:
determining, based on a blocked area of the obstacle in the vehicle-end data, whether the obstacle is at the edge of the blind spot of the autonomous driving vehicle.

3. The method according to claim 1, wherein the attribute estimated value comprises a position estimated value and/or a speed estimated value; and
the fusing the vehicle-end data and the V2X data to obtain the attribute estimated value of the obstacle, comprises:
scoring an attribute observed value collected by each sensor in the vehicle-end data and an attribute observed value in the V2X data respectively, wherein the attribute observed value comprises a position observed value and/or a speed observed value;
determining confidence levels of the attribute observed values in a Kalman filter based on a scoring result; and
calculating to obtain the position estimated value and/or the speed estimated value of the obstacle based on the confidence levels of the attribute observed values.

4. The method according to claim 3, wherein the calculating to obtain the position estimated value and/or the speed estimated value of the obstacle based on the confidence levels of the attribute observed values, comprises:
determining an R matrix in the Kalman filter corresponding to the attribute observed values based on the confidence levels of the attribute observed values; and
calculating to obtain the position estimated value and/or the speed estimated value of the obstacle based on the R matrix.

5. The method according to claim 3, wherein, in response to determining that the attribute estimated value comprises the speed estimated value, the scoring the attribute observed value collected by each sensor in the vehicle-end data and the attribute observed value in the V2X data respectively, comprises:
scoring the speed observed value collected by each sensor in the vehicle-end data and the speed observed value in the V2X data in different dimensions respectively, wherein the different dimensions comprise a size dimension, a direction dimension, and a dynamic and static dimension.

6. The method according to claim 1, wherein, the attribute estimated value comprises a category estimated value; and
the fusing the vehicle-end data and the V2X data to obtain the attribute estimated value of the obstacle, comprises:
acquiring a category observed value collected by each sensor in the vehicle-end data and a category observed value in the V2X data to obtain an observation sequence; and
inputting the observation sequence into a pre-trained hidden Markov model, to output to obtain the category estimated value of the obstacle.

7. The method according to claim 6, wherein the inputting the observation sequence into the pre-trained hidden Markov model, to output to obtain the category 5 estimated value of the obstacle, comprises:
obtaining state types corresponding to the category observed values in the observation sequence, based on a state transition probability matrix in the pre-trained hidden Markov model; and
fusing, based on an observation state transition probability matrix in the pre-trained hidden Markov model, the state types corresponding to the category observed values, to obtain the category estimated value of the obstacle.

8. An electronic device, comprising:
at least one processor; and
a memory communicatively connected to the at least one processor;
wherein the memory stores instructions executable by the at least one processor, and the instructions, when executed by the at least one processor, cause the at least one processor to perform operations, the operations comprising:
acquiring vehicle-end data collected by at least one sensor of an autonomous driving vehicle;
acquiring vehicle wireless communication vehicle to everything (V2X) data transmitted by a roadside device; and
fusing, in response to determining that an obstacle is at an edge of a blind spot of the autonomous driving vehicle, the vehicle-end data and the V2X data to obtain an attribute estimated value of the obstacle.

9. The electronic device according to claim 8, wherein the operations further comprise:
determining, based on a blocked area of the obstacle in the vehicle-end data, whether the obstacle is at the edge of the blind spot of the autonomous driving vehicle.

10. The electronic device according to claim 8, wherein the attribute estimated value comprises a position estimated value and/or a speed estimated value; and
the fusing the vehicle-end data and the V2X data to obtain the attribute estimated value of the obstacle, comprises:
scoring an attribute observed value collected by each sensor in the vehicle-end data and an attribute observed value in the V2X data respectively, wherein the attribute observed value comprises a position observed value and/or a speed observed value;
determining confidence levels of the attribute observed values in a Kalman filter based on a scoring result; and
calculating to obtain the position estimated value and/or the speed estimated value of the obstacle based on the confidence levels of the attribute observed values.

11. The electronic device according to claim 10, wherein the calculating to obtain the position estimated value and/or the speed estimated value of the obstacle based on the confidence levels of the attribute observed values, comprises:
determining an R matrix in the Kalman filter corresponding to the attribute observed values based on the confidence levels of the attribute observed values; and
calculating to obtain the position estimated value and/or the speed estimated value of the obstacle based on the R matrix.

12. The electronic device according to claim 10, wherein, in response to determining that the attribute estimated value comprises the speed estimated value, the scoring the attribute observed value collected by each sensor in the vehicle-end data and the attribute observed value in the V2X data respectively, comprises:
scoring the speed observed value collected by each sensor in the vehicle-end data and the speed observed value in the V2X data in different dimensions respectively, wherein the different dimensions comprise a size dimension, a direction dimension, and a dynamic and static dimension.

13. The electronic device according to claim 8, wherein, the attribute estimated value comprises a category estimated value; and
the fusing the vehicle-end data and the V2X data to obtain the attribute estimated value of the obstacle, comprises:
acquiring a category observed value collected by each sensor in the vehicle-end data and a category observed value in the V2X data to obtain an observation sequence; and
inputting the observation sequence into a pre-trained hidden Markov model, to output to obtain the category estimated value of the obstacle.

14. The electronic device according to claim 13, wherein the inputting the observation sequence into the pre-trained hidden Markov model, to output to obtain the category estimated value of the obstacle, comprises:
obtaining state types corresponding to the category observed values in the observation sequence, based on a state transition probability matrix in the hidden Markov model; and
fusing, based on an observation state transition probability matrix in the hidden Markov model, the state types corresponding to the category observed values, to obtain the category estimated value of the obstacle.

15. A non-transitory computer readable storage medium storing computer instructions, wherein, the computer instructions are used to cause a computer to perform operations, comprising:
acquiring vehicle-end data collected by at least one sensor of an autonomous driving vehicle;
acquiring vehicle wireless communication vehicle to everything (V2X) data transmitted by a roadside device; and
fusing, in response to determining that an obstacle is at an edge of a blind spot of the autonomous driving vehicle, the vehicle-end data and the V2X data to obtain an attribute estimated value of the obstacle.

16. The non-transitory computer readable storage medium according to claim 15, wherein the operations further comprise:
determining, based on a blocked area of the obstacle in the vehicle-end data, whether the obstacle is at the edge of the blind spot of the autonomous driving vehicle.

17. The non-transitory computer readable storage medium according to claim 15, wherein the attribute estimated value comprises a position estimated value and/or a speed estimated value; and
the fusing the vehicle-end data and the V2X data to obtain the attribute estimated value of the obstacle, comprises:
scoring an attribute observed value collected by each sensor in the vehicle-end data and an attribute observed value in the V2X data respectively, wherein the attribute observed value comprises a position observed value and/or a speed observed value;
determining confidence levels of the attribute observed values in a Kalman filter based on a scoring result; and
calculating to obtain the position estimated value and/or the speed estimated value of the obstacle based on the confidence levels of the attribute observed values.

18. The non-transitory computer readable storage medium according to claim 17, wherein the calculating to obtain the position estimated value and/or the speed estimated value of the obstacle based on the confidence levels of the attribute observed values, comprises:
determining an R matrix in the Kalman filter corresponding to the attribute observed values based on the confidence levels of the attribute observed values; and
calculating to obtain the position estimated value and/or the speed estimated value of the obstacle based on the R matrix.

19. The non-transitory computer readable storage medium according to claim 17, wherein, in response to determining that the attribute estimated value comprises the speed estimated value, the scoring the attribute observed value collected by each sensor in the vehicle-end data and the attribute observed value in the V2X data respectively, comprises:
scoring the speed observed value collected by each sensor in the vehicle-end data and the speed observed value in the V2X data in different dimensions respectively, wherein the different dimensions comprise a size dimension, a direction dimension, and a dynamic and static dimension.

20. An autonomous driving vehicle, comprising the electronic device according to claim 8.
